(19) United States
(12) Patent Application Publication
(10) Pub. No.: US 2025/0282237 A1
(43) Pub. Date: Sep. 11, 2025

(54) ADAPTER FOR ELECTRIC VEHICLE CHARGING CONNECTORS

(71) Applicant: EVject, Inc., American Fork, UT (US)

(72) Inventors: Erick Vega, Salt Lake City, UT (US); Kreg Peeler, Draper, UT (US)

(21) Appl. No.: 18/598,641

(22) Filed: Mar. 7, 2024

(51) Int. Cl. B60L 53/16; B60L 53/30

(52) U.S. Cl. CPC B60L 53/16; B60L 53/30

(57) ABSTRACT

An adaptor for electric vehicle charging connectors allows an EV to be shifted from park even though the charging connector is still connected to the charging port. As a result, a driver need not leave the EV to unplug the charging connector. The adapter may include a trigger assembly that is movable relative to a switching element. When the trigger assembly is moved within proximity to the switching element, the switching element can establish an electrical connection to notify the EV that the charging connector is plugged into the charging port. The trigger assembly can also be configured to cause the switching element to terminate the electrical connection when charging is stopped.

### CROSS-REFERENCE TO RELATED APPLICATIONS

N/A

### BACKGROUND

Electric vehicles (or EVs), whether cars, trucks or otherwise, must be frequently recharged. For this purpose, EVs have charging ports that are typically located on the outside. FIGS. 1A and 1B provide an example of a Tesla 100 that has a charging port 110 into which a charging connector 120 can be plugged. Charging connector 120 can be electrically connected to a power source such as a 240-volt outlet at home or a public charging station. Other makes of EVs have similar charging ports that require similar charging connectors.

It can take a relatively long time to fully charge an EV. For example, with a typical 240-volt at-home charger, a full charge may take 8 hours. Even with high-voltage superchargers, it usually takes at least 30-40 minutes to reach a full charge.

Global EV charging standards prevent any motion of the EV while the EV is connected to a charger. Therefore, the vehicle must remain parked while connected to the charger and cannot be shifted to drive, reverse, or neutral. Additionally, current charger designs require manual removal of the charging connector from the charging port. This can create various difficulties.

Greater difficulties may arise in scenarios where the driver is waiting in the EV while it charges. For example, a thunderstorm or other severe weather could occur when charging is complete thus forcing the driver to brave the elements to unplug the EV. As another example, a charging station may be in a remote or dangerous location where it may be unsafe for the driver to exit the EV such as due to the presence of wildlife or a lurking assailant. In such cases, the driver will in essence be trapped inside the EV given that he or she cannot drive away until the EV is unplugged.

### BRIEF SUMMARY

The present invention extends to an adaptor for electric vehicle charging connectors. The adapter allows an EV to be shifted from park even though the charging connector is still connected to the charging port. As a result, a driver need not leave the EV to unplug the charging connector. The adapter may include a trigger assembly that is movable relative to a switching element. When the trigger assembly is moved within proximity to the switching element, the switching element can establish an electrical connection to notify the EV that the charging connector is plugged into the charging port. The trigger assembly can also be configured to cause the switching element to terminate the electrical connection when charging is stopped.

In some embodiments, an adapter for an electric vehicle may include an inner portion configured to insert into a charging port of an electric vehicle, an outer portion configured to receive a charging connector for the electric vehicle, a switching element that is configured to establish an electrical connection through one or more communication pin assemblies, and a trigger assembly that is moveable relative to the switching element. The trigger assembly can be configured to activate the switching element when the trigger assembly is moved within proximity to the switching element.

In some embodiments, the trigger assembly may include one or more magnetic components that activate the switching element when the trigger assembly is moved within proximity to the switching element or one or more activating portions that mechanically activate the switching element when the trigger assembly is moved within proximity of the switching element.

In some embodiments, the switching element may establish the electrical connection through the one or more communication pin assemblies by connecting a front portion and rear portion of each of the one or more communication pin assemblies.

In some embodiments, the switching element may be one or more reed switches, one or more hall effect switches, one or more hall effect sensors, one or more magnetoresistive sensors, or one or more electromagnetic relays.

In some embodiments, the trigger assembly may include a trigger, a first arm and a second arm.

In some embodiments, the trigger may be configured to move the first arm relative to the switching element.

In some embodiments, the first arm may include one or more magnetic components that activate the switching element when the first arm is moved within proximity to the switching element.

In some embodiments, the second arm may be configured to retain the first arm in proximity to the switching element.

In some embodiments, the second arm may be moved towards the first arm to retain the first arm in proximity to the switching element.

In some embodiments, the second arm may be configured to be moved towards the first arm when a locking tab of the charging port is extended.

In some embodiments, the second arm may include a ledge against which the first arm is held.

In some embodiments, the first arm may be biased away from the switching element.

In some embodiments, the first arm may be biased away from the switching element by the trigger.

In some embodiments, the trigger assembly may include a charging connector locking member that is extended into the outer portion when the trigger moves the first arm towards the switching element.

In some embodiments, the adapter may include power pin assemblies and a ground pin assembly.

In some embodiments, the ground pin assembly may include a front portion, a rear portion and a wire that interconnects the front portion and the rear portion.

In some embodiments, the outer portion may be configured to separate from the inner portion when the electric vehicle drives away while the charging connector is inserted into the outer portion and the inner portion is inserted into the charging port.

In some embodiments, an adapter for an electric vehicle may include an inner portion configured to insert into a charging port of an electric vehicle, an outer portion configured to receive a charging connector for the electric vehicle, a switching element that is configured to establish a communication connection between the charging connector and the electric vehicle, and a trigger assembly that is moveable relative to the switching element. The trigger assembly may be configured to activate the switching element when the trigger assembly is moved within proximity to the switching element to thereby cause the communication connection to be established.

In some embodiments, the trigger assembly may activate the switching element via magnetic force.

In some embodiments, an adapter for an electric vehicle may include an inner portion configured to insert into a charging port of an electric vehicle, an outer portion configured to receive a charging connector for the electric vehicle, a switching element, and a trigger assembly. The trigger assembly may include a trigger, a first arm and a second arm. The trigger may be configured to move the first arm towards the switching element to activate the switching element. The second arm may be configured to move towards the first arm in response to the switching element being activated.

### BRIEF DESCRIPTION OF THE DRAWINGS

FIGS. 1A and 1B provide an example of an EV with a charging port.

FIGS. 2A and 2B are front perspective and rear perspective views respectively of an adapter that is configured in accordance with one or more embodiments.

FIG. 3 is a cross-sectional side view of the adapter of FIGS. 2A and 2B.

FIGS. 4A and 4B are side and side perspective views respectively of internal components of an adapter that is configured in accordance with one or more embodiments such as the adapter of FIGS. 2A and 2B.

FIG. 5 is a rear perspective view of circuitry and communication pin assemblies that may be used in an adapter that is configured in accordance with one or more embodiments such as the adapter of FIGS. 2A and 2B.

FIG. 6 is an exploded side perspective view of power pin assemblies and a ground pin assembly that may be used in an adapter that is configured in accordance with one or more embodiments such as the adapter of FIGS. 2A and 2B.

FIGS. 7A and 7B are cross-sectional side views of the adapter of FIGS. 2A and 2B when in a default position and locked position respectively.

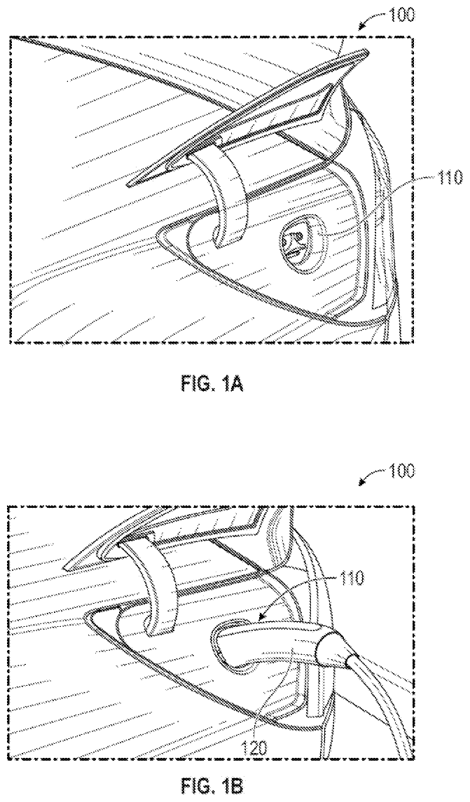

### DETAILED DESCRIPTION

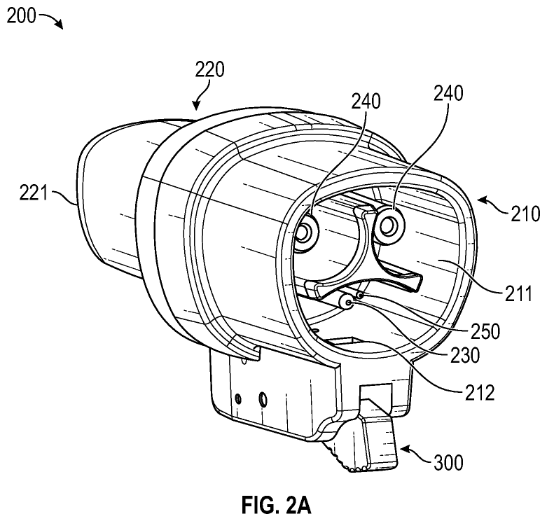

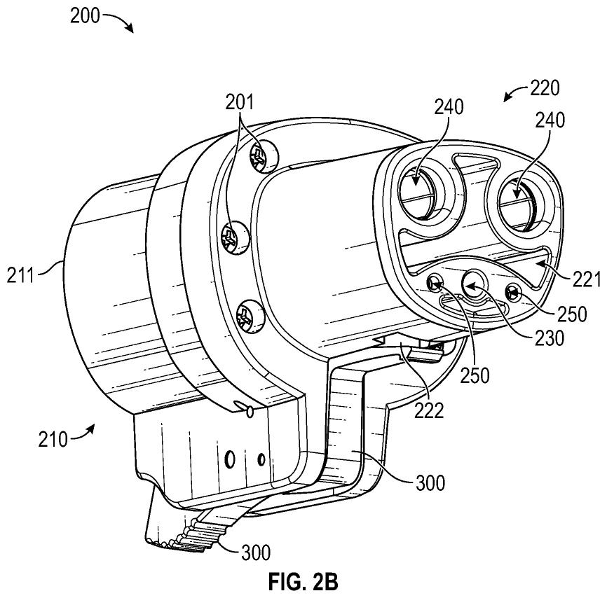

FIGS. 2A and 2B show an adapter 200 that is configured in accordance with one or more embodiments of the present disclosure. Adapter 200 includes an outer portion 210 having an end 211 that is configured to receive a charging connector for an EV (i.e., it can be shaped to match a charging port of the EV) and an inner portion 220 having an end 221 that is configured to be inserted into a charging port of the EV (i.e., it can be shaped to match the charging connector for the EV). Adapter 200 as depicted is for a Tesla, but an adapter configured in accordance with embodiments of the present invention could include outer and inner portions that are customized for any other EV. In some embodiments, outer portion 210 may be coupled to inner portion 220 by screws 201. However, any coupling mechanism or technique could be used including those that facilitate the breakaway functionality described below.

In some embodiments, outer portion 210 can include an opening 212 that is positioned to align with an opening in the charging connector that is configured to receive a locking tab (or other mechanism) of the EV's charging port. Similarly, in some embodiments, inner portion 220 can include an opening 222 that is configured to align with the locking tab (or other mechanism) of the EV's charging port.

Adapter 200 also includes a trigger assembly 300 that is configured to enable an electrical connection to be selectively formed between the EV's charging port and the charging connector when the charging connector is plugged into the charging port via adapter 200. In some embodiments, trigger assembly 300 may selectively lock adapter 200 within the charging port and/or lock the charging connector within adapter 200.

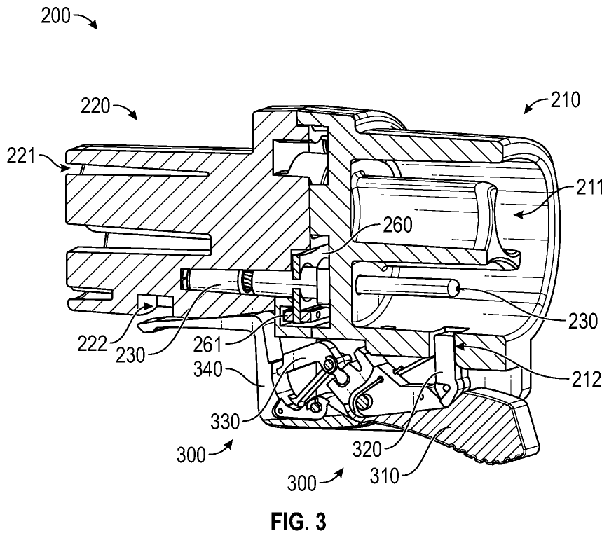

FIG. 3 is a cross-sectional side view of adapter 200 and shows how trigger assembly 300 may be configured in one or more embodiments. Trigger assembly 300 includes a trigger 310, a charging connector locking member 320, a first arm 330, and a second arm 340. In addition to trigger assembly 300, the internal components of adapter 200 may include a ground pin assembly 230, power pin assemblies 240 (not visible in FIG. 3), communication pin assemblies 250 (not visible in FIG. 3), and circuitry 260 having one or more switching elements 261.

Trigger 310 can be configured to extend out from outer portion 210 so that a user can apply a force to it to activate trigger assembly 300. For example, in some embodiments, trigger 310 may extend both downwardly and frontwardly from outer portion 210. In some embodiments, trigger 310 can be biased into its extended position.

Charging connector locking member 320 can be positioned to selectively extend through opening 212 when a force is applied to trigger 310. For example, in FIG. 3, charging connector locking member 320 is positioned above trigger 310 so that upward motion of trigger 310 forces charging connector locking member 320 through opening 212. In this way, charging connector locking member 320 can be positioned in the opening in the charging connector that is configured to receive the locking tab of the EV's charging port to thereby secure the charging connector to adapter 200. In some embodiments, charging connector locking member 320 could be a separate component from trigger 310, whereas, in other embodiments, charging connector locking member 320 could be an integral part of trigger 310.

First arm 330 can be configured to move within adapter 200 when trigger 310 is moved. For example, in some embodiments, first arm 330 could be pivotably coupled within adapter 200 and may include a front portion that is linked with trigger 310 and a rear portion that moves upwardly when trigger 310 is pulled.

Second arm 340 can be configured to move relative to adapter 200 when the locking tab of the EV's charging port is advanced. For example, in some embodiments, second arm 340 could be pivotably coupled within adapter 200 and could include a rear portion that is forced upward by the locking tab to thereby cause second arm 340 to pivot frontwardly towards first arm 330. As described in detail below, first arm 330 and second arm 340 can function to cause circuitry 260 to selectively form an electrical connection in one or both of communication pin assemblies 250.

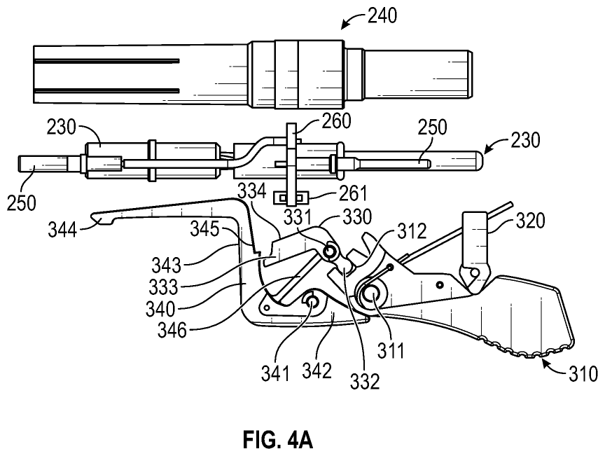

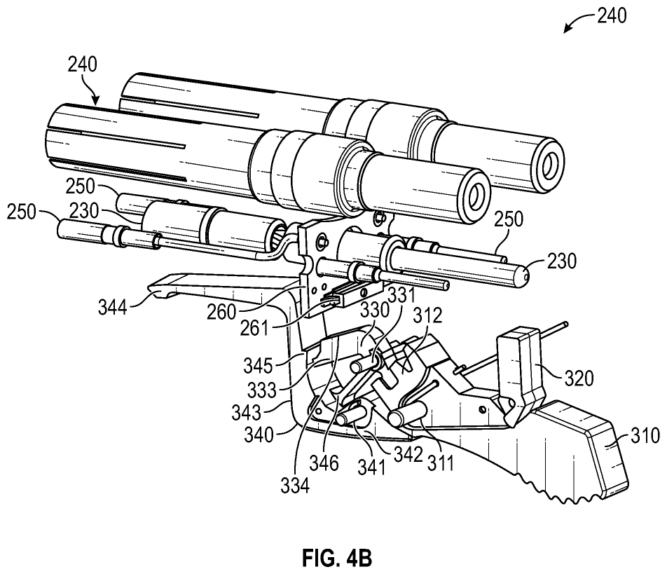

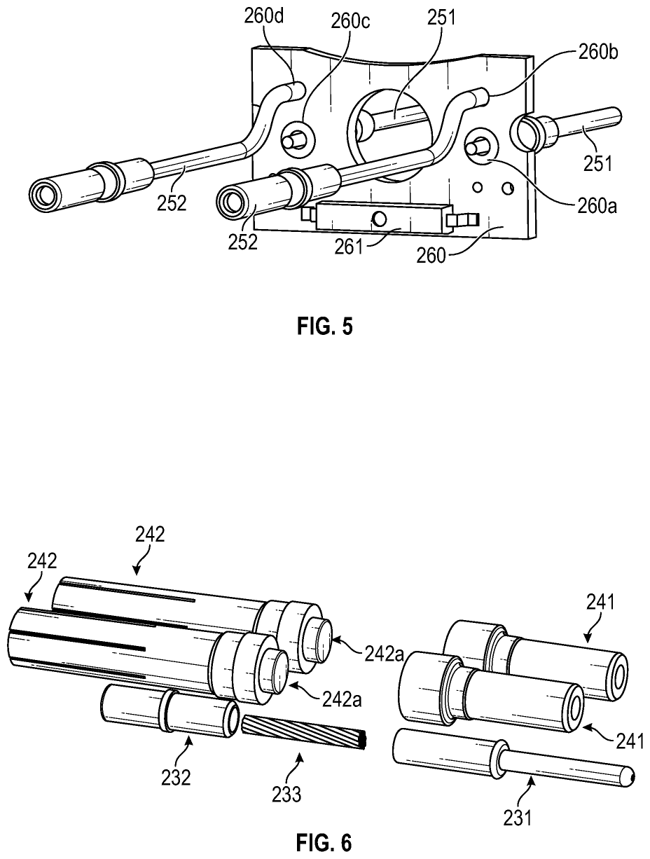

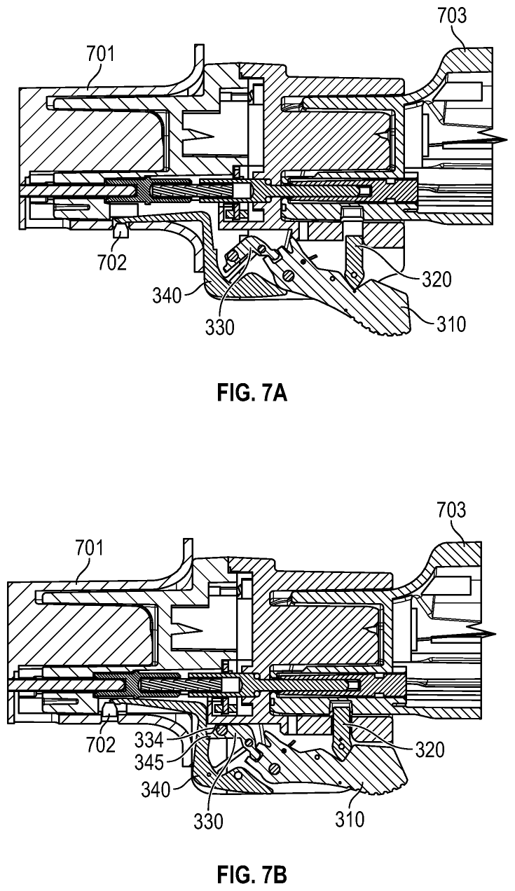

FIGS. 4A and 4B are side and side perspective views respectively of adapter 200 with outer portion 210 and inner portion 220 removed and therefore provide an example of how the internal components of adapter 200 could be configured in one or more embodiments. FIG. 5 is an isolated rear perspective view showing how circuitry 260 and communication pin assemblies 250 may be configured in one or more embodiments. FIG. 6 is an isolated side perspective view showing how ground pin assembly 230 and power pin assemblies 240 can be configured in one or more embodiments. FIGS. 7A and 7B are cross-sectional side views of adapter 200 when trigger assembly 300 is in its default position and locked position respectively. FIGS. 7A and 7B also show portions of a charging port 701 with a locking tab 702 and a charging connector 703 and therefore provide an example of adapter 200 in use.

Turning to FIG. 5, circuitry 260 could be in the form of a circuit board or any other suitable component that can electrically isolate a front portion 251 and a rear portion 252 of one or both of communication pin assemblies 250. For example, circuitry 260 could include a first pad 260a that is connected to a second pad 260b via switching element 261 and a third pad 260c that is connected to a fourth pad 260d via switching element 261. In such cases, when switching element 261 is closed, rear portions 252 will be connected to the respective front portions of communication pin assemblies 250.

The functionality of trigger assembly 300 will now be described with primary reference to FIGS. 4A and 4B and FIGS. 7A and 7B. As an overview, trigger assembly 300 can be configured to cause switching element 261 to be activated when trigger 310 is pulled and to remain activated while the EV is being charged.

Trigger 310 can be coupled to adapter 200 via a pivot point 311 that is positioned frontward of a rear portion 312 of trigger 310. In some embodiments, rear portion 312 can be structured as a receptacle in which a front portion 332 of first arm 330 is positioned. One or more biasing members (e.g., springs) can be used to bias trigger 310 into the extended position shown in FIGS. 4A and 4B.

First arm 330 can be coupled to adapter 200 via a pivot point 331 that is positioned between front portion 332 and a rear portion 333 of first arm 330. In some embodiments, rear portion 333 may be angled relative to front portion 332 (e.g., at an angle between 45 and 90 degrees). Trigger 310 can be coupled to first arm 330 in a manner that causes rear portion 333 of first arm 330 to be moved towards switching element 261 when trigger 310 is pulled. For example, front portion 332 of first arm may be rotated downwardly/rearwardly as trigger 310 is pulled to thereby cause rear portion 333 to rotate upwardly/frontwardly.

One or more magnetic components 334 can be positioned on/in rear portion 333 and can activate switching element 261 when within sufficient proximity such as when rear portion 333 is elevated in response to trigger 310 being pulled. Switching element 261 could be any suitable configuration for connecting front portion 231 and rear portion 232 of one or both communication pin assemblies 230 based on the proximity of rear portion 333 (or more particularly in the depicted embodiments, based on the proximity of magnetic components 334). For example, switching element 261 could be one or more reed switches, one or more hall effect switches, one or more hall effect sensors, one or more magnetoresistive sensors, one or more electromagnetic relays, etc. As described in more detail below, when the electrical connection through one or both communication pin assemblies 230 is established, the EV will extend its locking tab 702 to attempt to lock the charging connector (or in this case, adapter 200) in the charging port 701.

In other embodiments, rear portion 333 could be structured (or could include a structure) that is configured to mechanically activate switching element 261 when rear portion 333 is within sufficient proximity. For example, rear portion 333 could include an activating portion that is lifted into contact with switching element 261 to thereby cause front portion 231 and rear portion 232 of one or both communication pin assemblies 230 to be connected. For example, the activating portion could be lifted against a button or other movable component that completes a circuit of switching element 261. As another example, the activating portion could be conductive and could insert into switching element 261 or otherwise contact switching element 261 in a manner that completes a circuit of switching element 261 through the activating portion.

Second arm 340 can be coupled to adapter 200 via a pivot point 341 that may be positioned at a front portion 342 of second arm 340. An intermediate portion 343 may extend from front portion 343 and a rear portion 344 may extend from intermediate portion 343. In some embodiments, intermediate portion 343 may be oriented generally vertically while front portion 342 and rear portion 344 may extend generally horizontally in opposition directions from the bottom and top respectively of intermediate portion 343. However, many other shapes/configurations of second arm 340 could equally be used.

As is best shown in FIG. 7B, rear portion 344 is configured to extend overtop opening 222 so that the locking tab 702 of the EV's charging port 701 will lift rear portion 344 when the locking tab 702 is extended. Opening 222 and/or inner portion 220 of adapter 200 can be configured to allow rear portion 344 and intermediate portion 343 of rear arm 340 to pivot upwardly/rearwardly when the locking tab 702 is extended. This frontward pivoting of second arm 340 can cause first arm 330, and therefore magnetic components 334, to remain in proximity to switching element 261 to thereby maintain the electrical connection for as long as the EV keeps the locking tab 702 extended, which the EV is configured to do as long as it senses power on the power pins of the charging port 701. Also, while second arm 340 holds first arm 330 in the lifted position, first arm 330 will also hold trigger 310 in its lifted position to cause charging connector locking member 320 to remain in its lifted position through opening 212 to thereby lock the charging connector 703 within outer portion 210 of adapter 200.

In some embodiments, intermediate portion 343 may form a ledge 345 on which the tip of rear portion 333 of first arm 330 may rest as shown in FIG. 7B. In other words, ledge 345 may prevent first arm 330 from lowering until the EV withdraws the locking tab 702 which will in turn allow second arm 340 to return to its resting position shown in FIG. 7A. In some embodiments, second arm 340 can be separately biased into this resting position. In other embodiments, second arm 340 could be configured to fall due to gravity into this resting position. In other embodiments, the biasing of trigger 310 may apply a sufficient rotational force on first arm 330 to cause first arm 330 to push intermediate portion 343 rearwardly to thereby cause second arm 340 to return to its resting position. In short, any suitable configuration could be used to ensure that second arm 340 is withdrawn to allow first arm 330 to lower away from switching element 261 when the EV withdraws its locking tab 702.

Once first arm 330 is lowered sufficiently away from switching element 261, magnetic components 334 will no longer activate switching element 261 thereby causing the electrical connection through one or both communication pin assemblies 230 to be disconnected. This disconnection will cause the EV to believe that the charging connector 703 has been removed from the charging port 701 even though the charging connector 703 remains plugged in via adapter 200. At this point, the EV will allow the driver to shift from park and drive away if necessary.

To minimize the risk of damage to the EV, its charging port 701 and/or the charging connector 703, adapter 200 can be configured to break apart when the EV drives away while the charging connector 703 is still plugged in. For example, screws 201 and or the threaded openings into which they insert can be configured to strip when a sufficient force is applied. As a result, outer portion 210 with the charging connector 703 inserted will pull apart from inner portion 220 which remains inserted into the charging port 701.

FIG. 6 shows one suitable configuration of ground pin assembly 230 and power pin assemblies 240 to facilitate the breaking apart of adapter 200. In some embodiments, ground pin assembly 230 could include a front portion 231, a rear portion 232, and a connector portion 233 that electrically interconnects front portion 231 and rear portion 232. In some embodiments, connector portion 233 may be a length of wire that is press fit into opposing openings in front portion 231 and rear portion 232. In some embodiments, power pin assemblies 240 could include a front portion 241 and a rear portion 242. One of these portions can be configured to press fit into an opening in the other portion. For example, in the depicted embodiments, rear portion 242 includes an extension 242a that is press fit into an opening in front portion 241. Because of these press fit connections, ground pin assembly 230 and power pin assemblies 240 can easily pull apart as outer portion 210 is separated from inner portion 220.

With reference to FIG. 5, communication pin assemblies 250 can also be configured to pull apart or separate from outer portion 210 or inner portion 220. For example, in some instances, rear portions 252 could pull out from inner portion 220 and/or front portions 251 could pull out from outer portion 210. As another example, in some instances, circuitry 260 could break apart or front portions 251 and/or rear portions 252 could pull out from circuitry 260.

In summary, an adapter configured in accordance with one or more embodiments can provide a way to shift an EV from park without having to unplug the charging connector. Such an adapter can also be configured to break apart to minimize damage when the charging connector is pulled away from the charging port.

As suggested above, an adapter configured in accordance with one or more embodiments can be designed for use with any type of EV and any type of charging connector (e.g., NACS, CCS, J1772, etc.). For example, outer portion 210 could be configured to match other types/shapes of charging connectors and/or inner portion 220 could be configured to match other types/shapes of charging ports. Various different configurations of the power pin assemblies, ground pin assembly, and/or communication pin assemblies can be used depending on the type of charging port and the type of charging connector for which the adapter is designed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. An adapter for an electric vehicle comprising:
an inner portion configured to insert into a charging port of an electric vehicle;
an outer portion configured to receive a charging connector for the electric vehicle;
a switching element that is configured to establish an electrical connection through one or more communication pin assemblies; and
a trigger assembly that is moveable relative to the switching element, the trigger assembly being configured to activate the switching element when the trigger assembly is moved within proximity to the switching element.

2. The adapter of claim 1, wherein the trigger assembly includes one of:
one or more magnetic components that activate the switching element when the trigger assembly is moved within proximity to the switching element; or
one or more activating portions that mechanically activate the switching element when the trigger assembly is moved within proximity of the switching element.

3. The adapter of claim 2, wherein the switching element establishes the electrical connection through the one or more communication pin assemblies by connecting a front portion and rear portion of each of the one or more communication pin assemblies.

4. The adapter of claim 1, wherein the switching element comprises one of:
one or more reed switches;
one or more hall effect switches;
one or more hall effect sensors;
one or more magnetoresistive sensors; or
one or more electromagnetic relays.

5. The adapter of claim 1, wherein the trigger assembly comprises a trigger, a first arm and a second arm.

6. The adapter of claim 5, wherein the trigger is configured to move the first arm relative to the switching element.

7. The adapter of claim 6, wherein the first arm includes one or more magnetic components that activate the switching element when the first arm is moved within proximity to the switching element.

8. The adapter of claim 7, wherein the second arm is configured to retain the first arm in proximity to the switching element.

9. The adapter of claim 8, wherein the second arm is moved towards the first arm to retain the first arm in proximity to the switching element.

10. The adapter of claim 9, wherein the second arm is configured to be moved towards the first arm when a locking tab of the charging port is extended.

11. The adapter of claim 9, wherein the second arm includes a ledge against which the first arm is held.

12. The adapter of claim 9, wherein the first arm is biased away from the switching element.

13. The adapter of claim 12, wherein the first arm is biased away from the switching element by the trigger.

14. The adapter of claim 6, wherein the trigger assembly further includes a charging connector locking member that is extended into the outer portion when the trigger moves the first arm towards the switching element.

15. The adapter of claim 1, further comprising:
power pin assemblies; and
a ground pin assembly.

16. The adapter of claim 15, wherein the ground pin assembly comprises a front portion, a rear portion and a wire that interconnects the front portion and the rear portion.

17. The adapter of claim 1, wherein the outer portion is configured to separate from the inner portion when the electric vehicle drives away while the charging connector is inserted into the outer portion and the inner portion is inserted into the charging port.

18. An adapter for an electric vehicle comprising:
an inner portion configured to insert into a charging port of an electric vehicle;
an outer portion configured to receive a charging connector for the electric vehicle;
a switching element that is configured to establish a communication connection between the charging connector and the electric vehicle; and
a trigger assembly that is moveable relative to the switching element, the trigger assembly being configured to activate the switching element when the trigger assembly is moved within proximity to the switching element to thereby cause the communication connection to be established.

19. The adapter of claim 18, wherein the trigger assembly activates the switching element via magnetic force.

20. An adapter for an electric vehicle comprising:
an inner portion configured to insert into a charging port of an electric vehicle;
an outer portion configured to receive a charging connector for the electric vehicle;
a switching element; and
a trigger assembly comprising a trigger, a first arm and a second arm, wherein the trigger is configured to move the first arm towards the switching element to activate the switching element, and wherein the second arm is configured to move towards the first arm in response to the switching element being activated.
